(19) United States
(12) Patent Application Publication
(10) Pub. No.: US 2004/0210934 A1
(43) Pub. Date: Oct. 21, 2004

(54) Video program guide system

(76) Inventor: Han-Ping Chen, Saratoga, CA (US)

Correspondence Address: Han-Ping Chen, P.O. Box 2871, Saratoga, CA, 95070, US

(21) Appl. No.: 10/418,722

(22) Filed: Apr. 18, 2003

(51) Int. Cl. H04N 5/445; H04N 5/45; G06F 13/00; G06F 3/00

(52) U.S. Cl. 725/41; 725/44; 348/565; 348/564

(57) ABSTRACT

A method and apparatus retrieves and interactively displays program guide information by analyzing the program information screen images from the video source provider on a dedicated service channel; with the unilateral processing at the viewer end alone. Also, the present invention provides a method to supply additional program information with special image patterns in selected screen areas. The present invention further provides the ability for the viewer to select programs for future viewing or recording.

### BACKGROUND OF THE INVENTION

This invention relates to video, television, and program guides.

Video and television systems sometimes provide electronic program guides to view program listings or to control video recording devices.

Program guide data are distributed to the video or television systems through broadcasting, cable, or satellite signals. Special control units may also retrieve program guide data through telephone networks or the Internet.

To accomplish this, both the video source provider equipment and the user end receiver system must comply certain hardware and software requirements.

When distributed through video signals, the program guide data are typically encoded in the vertical blanking interval.

On the hardware side, the video source provider equipment must contain vertical blanking interval signal generation capabilities. The user end video or television receivers must also have vertical blanking interval processing capabilities.

Furthermore, any repeaters, relays, or other video transmission facilities from the source to the end users must all contain such transmission and processing capabilities.

On the software side, the sending and receiving systems must follow a specific data transfer protocol. This protocol is application dependent, according to the particular program guide system. The protocol is based on certain bilateral data transfer format specifications between the source provider equipment and the end user receiver system.

Due to this limitation, a large number of community video and television distribution systems still do not have a cost-effective way to provide electronic program guides to the end users.

As a result, many video source providers just display channels and program listings using ordinary video screen images on a special service channel. On this service channel, the video screen cycles through the listings for each broadcasting channel. The video screen changes normally every 10 or more seconds, enough for the viewer to read through. The viewer needs to stay tuned to this channel for 10 or more minutes to cycle through the listings for a cable system of 60 channels. This is not responsive enough in most cases.

### BRIEF SUMMARY OF THE INVENTION

This invention proposes a method and apparatus to distribute and receive program guide information that is cost-effective to the source providers and responsive enough for the end viewers.

This invention provides a method and apparatus to retrieve and interactively display program guide data with unilateral processing of ordinary video screen images at the viewer end alone.

This invention further provides a method for a video source provider to deliver extensive program guide data with none or minimal changes to existing video distribution and transmission facilities.

### BRIEF DESCRIPTION OF THE DRAWINGS

FIG. 1 is a diagram of a prior art video program guide system.

FIG. 2 shows a preferred embodiment of the present invention for a video program guide system.

FIG. 3 shows an example of a video program information source screen.

FIG. 4 shows a preferred embodiment of the present invention for a program guide database.

FIG. 5 shows another preferred embodiment of the present invention for a program guide database.

FIG. 6 shows a screen form to present the program guide information.

FIG. 7 shows another screen form to present the program guide information.

FIG. 8 shows another example of a video program information source screen.

FIG. 9 shows an enlarged portion of an image stripe for the video source screen.

FIG. 10 shows a preferred embodiment of the present invention for a remote control unit.

### DETAILED DESCRIPTION OF THE INVENTION

The present invention will be illustrated with some preferred embodiments.

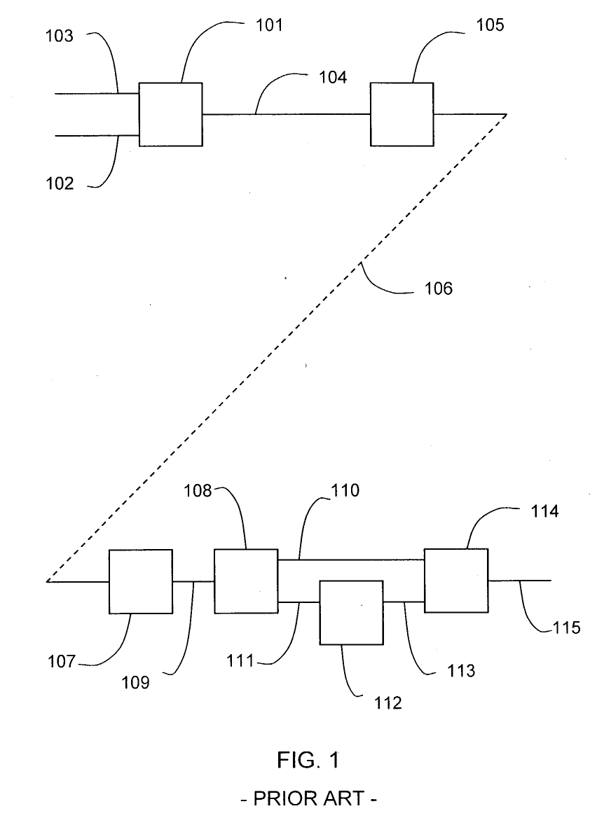

FIG. 1 is a diagram of a prior art video program guide system. In vertical blanking interval data encoder 101, the program guide data 102 is added to the regular video image 103 to form a combined video signal 104.

The combined video signal 104 is sent through the video signal transmitter 105 and the video transmission media 106.

In the case of cable television, this combined video signal is a composite video signal, typically according to the NTSC standard in the US, or a choice of the NTSC, PAL or SECAM standards in other countries.

A number of composite signals may also be multiplexed into a modulated broadcasting signal for cable television transmission.

At the viewer end, the video signal receiver 107 receives the video signal from the video transmission media 106. For modulated broadcasting system, the video signal receiver includes a channel tuner to select a video signal channel. The selected video signal is transformed back to a composite video signal of the appropriate signal standard.

The vertical blanking interval data decoder 108 separates the combined video signal 109 into the regular video signal 110 and program data 111.

The program data control unit 112 controls the display of program data and generates program data display signal 113. Based on the regular video signal 110 and the program data display signal 113, the video display unit 114 generates the output video signal 115 to be displayed on the video or television screen. The output video signal is once again in the appropriate signal standard format.

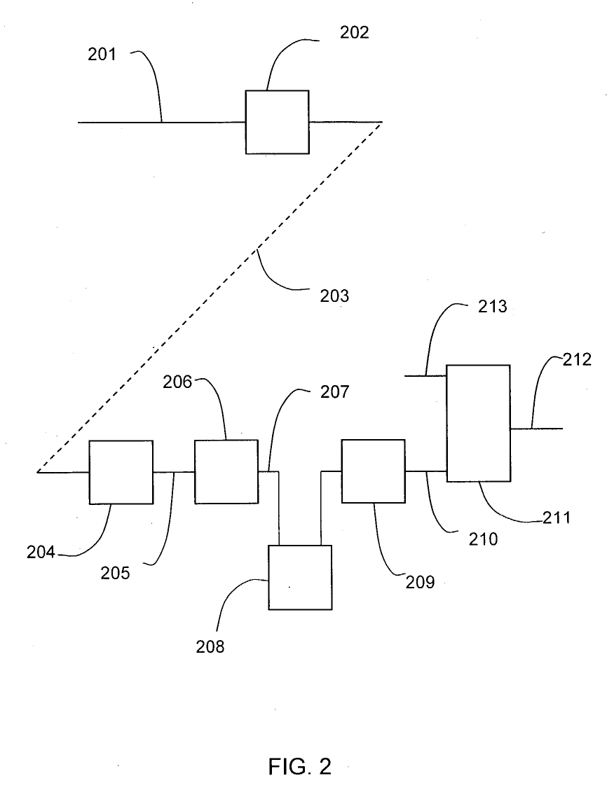

FIG. 2 shows a preferred embodiment of the present invention for a video program guide system.

The regular video image 201 is sent through the video signal transmitter 202 and the video transmission media 203. The regular video image 201 is in regular visible screen image format. It does not go through an encoding process.

In the case of cable television, this video image is a composite video signal according to the appropriate signal standard. For modulated broadcasting transmission, the video source provider transmits the program guide video image on a dedicated service channel.

At the viewer end, the video signal receiver 204 receives the video signal from the video transmission media 203.

For modulated broadcasting system, the video signal receiver includes a channel tuner to select the dedicated service channel and transform it back to a composite video signal of the appropriate signal standard.

A video image-processing unit 206 retrieves program data 207 from the video image 205 and stores into the program data storage 208. The video image-processing unit 206 may store the bitmap image of the full screen, partial screen, or selected areas of the video image 205. To conserve storage capacity, it may also store the target bitmap in simplified, modified, or compressed forms.

On the dedicated service channel, the video source screen image periodically cycles through a number of screen image patterns, one for each channel, showing the channel number, channel name, and a list of program entries.

The video image-processing unit 206 may compare selected areas of two consecutive screens for significant changes and stores only one screen for each image pattern. An ideal image area to select for comparison is the area that shows the channel number.

In addition, the video image-processing unit 206 may perform certain image processing or character recognition operations to transform selected parts of the source video screen image into numeric or alphabetic characters. These characters are easier to store. The characters may also be used for other system functions such as channel number indexing or time slot distinction.

A program data control unit 209 controls the display of program data and generates program data display signal 210. Based on the program data display signal 210, the video display unit 211 generates the output video signal 212 to be displayed on the video or television screen.

If the program data display signal 210 is generated from previously stored program data, the video display unit 211 may optionally overlays the program data display 210 onto the current real-time video signal 213 to generate the output video signal 212. The current real-time video signal may be a regular television program that the viewer is currently viewing, or a pre-recorded program that the viewer is currently playing back.

The real-time video signal 213 may be the video image 205 from the video signal receiver 204, currently tuned to a channel other than the dedicated service channel. It may also be from another internal or external video signal receiver.

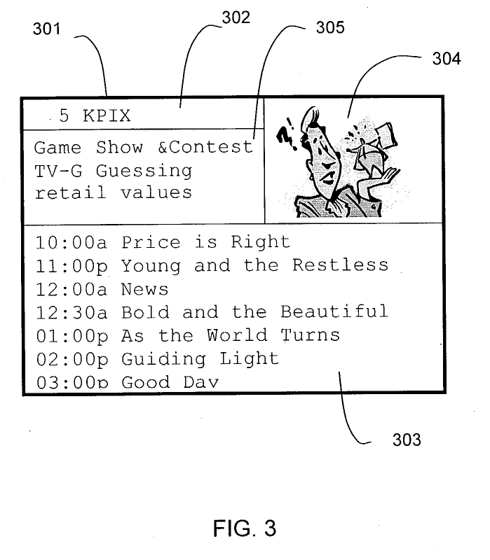

FIG. 3 shows an example of a video program information source screen from the video source provider. Screen 301 shows a list of programs for a particular channel. Area 302 shows the channel number and channel name. Area 303 lists a number of programs by the starting time, starting from the current program. Area 304 is a condensed version of the video image showing the current program on the target channel. Area 305 contains the description of the current program on the channel. It may also contain other special messages.

Since area 304, the condensed version of the current channel video, may be a moving image, it is not suitable for distinguishing program information screen image changes. Screen 304 is also likely to occupy more memory space. To conserve program guide data storage, it may not be included as a part of the essential database elements.

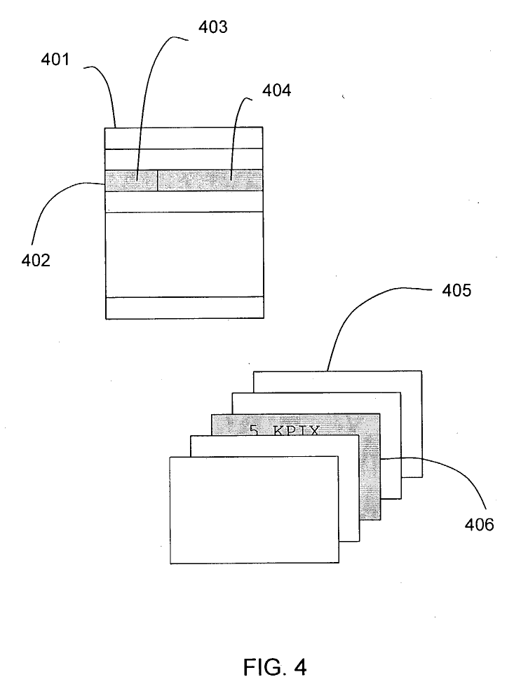

FIG. 4 shows a preferred embodiment of the present invention for a program guide database. In this preferred embodiment, the program guide data are stored in a full or partial screen bitmap format.

The program database includes a screen index table 401, which lists a number of stored screens. Each screen index table entry 402 contains a screen pointer 403, pointing to the memory location for the full or partial screen bitmap.

In case that the full or partial screens are stored in simplified or compressed form, the screen table entry 402 may also contain a bitmap parameter field 404 to describe the bitmap memory size or other formatting parameters.

The screen pointer 403 points to a screen image buffer area 406 within a screen image data structure 405.

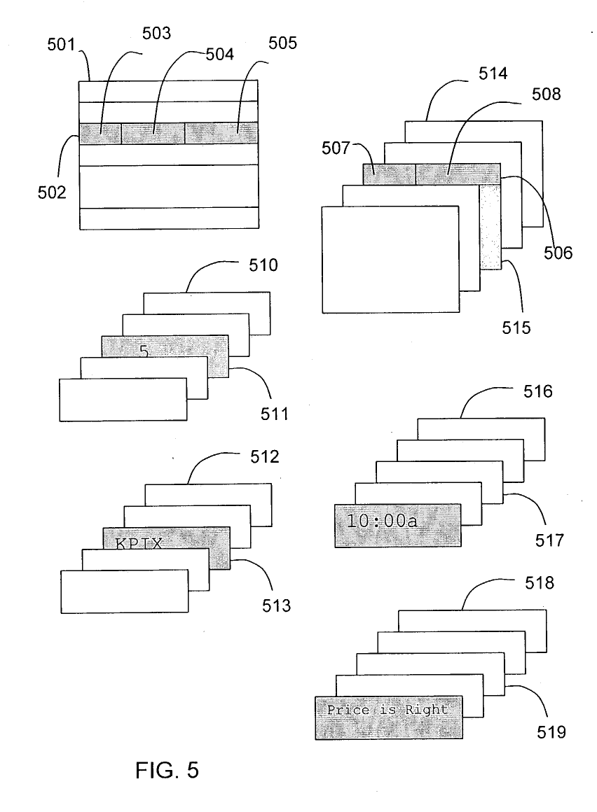

FIG. 5 shows another preferred embodiment of the present invention for a program guide database. In this preferred embodiment, the program guide screens are divided into functional blocks.

The contents of the functional blocks are as described in FIG. 3. The present invention may perform image processing or character recognition operations to transform some of these image blocks into numeric or alphabetic characters.

The program database includes a channel index table 501, which lists a number of channels. Each channel index entry 502 contains a channel number field 503. The channel number field 503 may be an image pointer to a channel number image block 511 in the channel number image structure 510. It may also be an explicit channel number code previously transformed from the channel number image block.

A channel index entry 502 may also contain a channel name field 504. The channel name field 504 may be an image pointer to a channel name image block 513 in the channel name image structure 512. It may also be an explicit channel name text string previously transformed from the channel name image block.

A channel index entry 502 may also contain a channel program data pointer 505 to point to a channel program data sub-table entry 515 in a channel program data sub-table structure 514. The channel program data sub-table entry 515 contains a list of program entries by the time slot. A program data entry 506 may contain a time slot field 507 and a program name field 508.

The time slot field 507 may be an image pointer to a time slot image block 517 in a time slot image structure 516. It may also be an explicit time slot code or time slot text string previously transformed from the time slot image block.

The program name field 508 may be an image pointer to a program name image block 519 in a program name image structure 518. It may also be an explicit program name text string previously transformed from the program name image block.

The output program guide screen to be displayed on the video or television screen may take a number of forms. The first program guide screen form resembles the original program information source screen image, as shown in FIG. 3. It shows the channel number, channel name, and a list of the current and upcoming programs. This time, however, the program guide screens are shown in a more responsive fashion, immediately and interactively according to the user commands.

The first program guide screen form may be generated directly from the stored full or partial program screen without major formatting and alteration. It may also be assembled from a combination of the divided image blocks or the transformed alphanumeric characters.

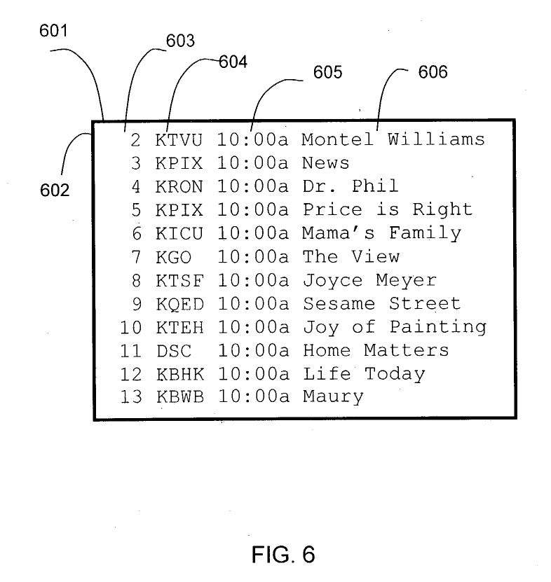

FIG. 6 shows another screen form to present the program guide information. Screen 601 lists the program in the current time slot for a number of channels. A program entry 602 contains a channel number 603, a channel name 604, a starting time 605, and a program name 606. Since it is in a form different from the original program data screen, it needs to be assembled from a combination of the divided image blocks or the transformed alphanumeric characters.

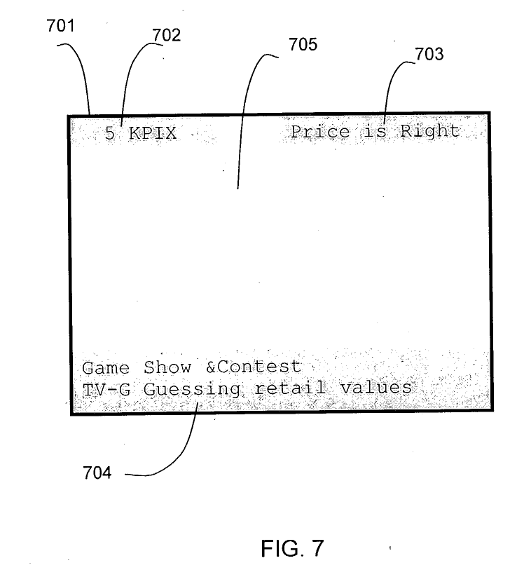

FIG. 7 shows another screen form to present the program guide information. Screen 701 shows the description of the current program in the current time slot. The screen includes the channel number and name 702, the program name 703, and a program description 704. In this example, the center portion 705 of the screen is reserved to display real-time video image of the current selected channel.

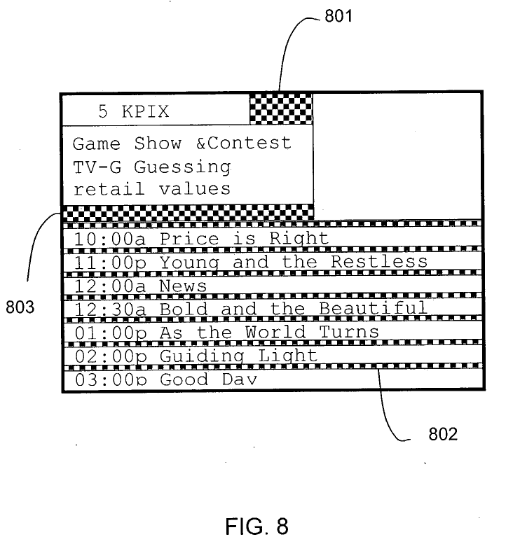

FIG. 8 shows another example of a video program information source screen from the video source provider. In addition to the normal character display, it contains special image stripes 801, 802, and 803 at selected locations. These locations are shown as patterned areas.

Image stripe 801 is located next to the channel name. Image stripes 802 are located above the program entries. Image stripe 803 is located in the lower portion of the program description.

These special image stripes contain special patterns that are functionally similar to a bar code, except in two dimensions. With these image stripes, a source image screen can carry additional program guide information to deliver to the viewer.

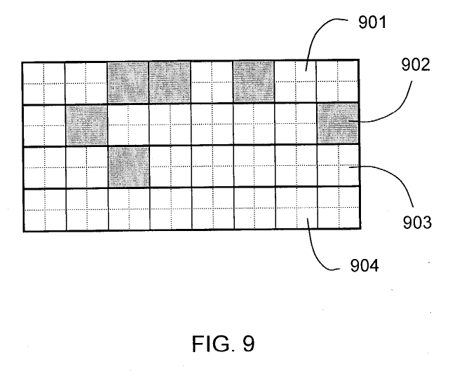

FIG. 9 shows an enlarged portion of a special image stripe for the video source screen in FIG. 8. To ensure the accurate delivery of the special image patterns from the video provider to the end viewer, the minimum resolution unit of the image pattern is defined to be a number of lines by a number of pixels. In FIG. 9, it is shown as a 4-by-4 block.

In FIG. 9, this portion of the image stripe contains four ASCII character codes, shown one character code on top of another. They may be viewed as the first character of four horizontal pattern rows. Segment 901 contains the code 0011,0100, the ASCII code for the number “4”. Segment 902 contains the code 0100,0001, the code for the letter “A”. Segment 903 contains the code 0010,0000 for a space symbol. Segment 904 contains a null code 0000,0000, which may be used as an end of string mark.

To accommodate the special image pattern stripes, the video image-processing unit, such as unit 206 in FIG. 2, needs to perform image-processing functions to transform these image patterns into character codes at the viewer end.

The source provider must generate these patterns when preparing the program guide screen.

However, the generation of these patterns only requires software changes or data changes. It does not require hardware changes in the video source provider equipment.

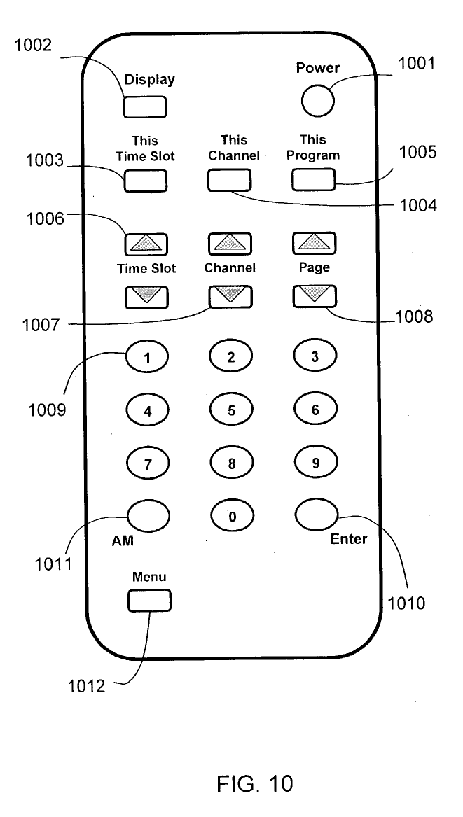

FIG. 10 shows a preferred embodiment of the present invention for a remote control unit for the user to control the basic operations of the program guide system.

Power button 1001 controls the power on and off. Button 1002 turns on and off of the program guide display. Button 1003 selects the operation mode to display the selected time slot. It controls the screen to list all the channels and the corresponding programs in the selected time slot. Button 1004 selects the operation mode to display the selected channel. It controls the screen to list the programs by the time slot for the selected channel. Button 1005 selects the operation mode to display the selected program. It controls the screen to show the description for the selected program.

Button pair 1006 moves the time slot selection up or down. Button pair 1007 moves the channel selection up or down. Button pair 1008 moves the display page up or down.

The array of numerical buttons 1009 provides numerical entries for the channel number or time slot in various commands. Button 1010 is the entry button. Button 1011 specifies AM for time slot entries. Button 1012 controls the menu operation to change system settings.

In addition to provide viewable screens, the program guide system can also provide the viewer the ability to pre-select television programs to view in the future.

To accomplish this, the program guide system needs to use an internal or external channel tuner to select the real-time video signal. This channel tuner may be within the video signal receiver, specified as receiver 204 in FIG. 2. It may be another built-in internal tuner, or an external tuner that is controllable by the program guide system.

Certain external channel tuners or video cassette recorders accept infrared signal inputs to select video channels. The program guide system may include an infrared signal transmitter to control such devices.

In addition to select a channel for viewing, the program guide system may also use the infrared transmitter to control a video cassette recorder to record a set of selected programs.

With the available program guide information, the program guide system may also generate a title screen to insert at the beginning of a program and send to the video cassette recorder for recording. The title page may include the channel number, channel name, starting time, and a description of the program.

I claim:

1. A video program guide system comprising:
(a) a primary analog video signal input line;
(b) a primary analog video signal interface unit;
(c) a screen image processing unit;
(d) a program guide data storage unit;
(e) a program guide display unit;
wherein said primary analog video signal interface unit receives a primary video signal from said primary analog video signal input line and sends it to said screen image processing unit;
wherein said primary video signal contains a plurality of program guide source screen images which contain channel numbers in numeric font image form and program entries in alphanumeric font image form or in bitmap image form;
wherein said screen image processing unit retrieves and selectively stores a number of said program guide source screen images into said program guide data storage unit;
wherein said program guide display unit uses said program guide source screen images to generate an output video display signal.

2. The video program guide system of claim 1, wherein said primary video signal is from a local or remote video source, such as cable, broadcast, satellite, VCR, VCD, DVD, or other video producing or recording devices.

3. The video program guide system of claim 1,
wherein said screen image processing unit stores the full screen image, a partial screen image, or selected screen image areas;
wherein said screen image processing unit stores the screen image or image areas in full bitmap, simplified, modified, or compressed forms.

4. The video program guide system of claim 1, wherein said screen image processing unit analyzes said screen images to determine whether there is a significant content change in selected image areas and only stores the distinguishable revisions of screen image contents.

5. The video program guide system of claim 1 wherein said screen image processing unit further performs image-processing or character-recognition operations to transform selected parts of the source video screen into numeric or alphabetic characters.

6. The video program guide system of claim 1 wherein said video display unit further overlays the program guide information onto a secondary analog or digital video signal to generate the output video display signal.

7. The video program guide system of claim 1 further comprises a tuner control unit wherein said tuner control unit controls an internal or external channel tuner to select a video channel for viewing at a selected starting time.

8. The video program guide system of claim 1 further comprises a recorder control unit wherein said recorder control unit controls a video recording device to record a selected program at the selected time. Said video program guide system may optionally send a title screen to the recording device to describe the channel number, channel name, program time, or program name.

9. A video program guide system comprising:
(a) a primary analog video signal input line;
(b) a primary analog video signal interface unit;
(c) a screen image processing unit;
(d) a program guide data storage unit;
(e) a program guide display unit;
wherein said primary analog video signal interface unit receives a primary video signal from said primary analog video signal input line and sends it to said screen image processing unit;
wherein said primary video signal contains a plurality of program guide source screen images which contain channel numbers in numeric font image form and program entries in alphanumeric font image form or in bitmap image form;
wherein said screen image processing unit analyzes said screen images to retrieve the program guide information and stores into said program guide data storage unit;
wherein said screen image processing unit performs image-processing or character-recognition operations to transform selected parts of the source video screen into numeric or alphabetic characters;
wherein said program guide display unit uses the program guide information to generate an output video display signal.

10. The video program guide system of claim 9, wherein said primary video signal is from a local or remote video source, such as cable, broadcast, satellite, VCR, VCD, DVD, or other video producing or recording devices.

11. The video program guide system of claim 9,
wherein said screen image processing unit stores the program guide information in character form, full screen image, partial screen image, or selected screen image areas;
wherein said screen image processing unit stores the screen image or image areas in full bitmap, simplified, modified, or compressed forms.

12. The video program guide system of claim 9 wherein said video display unit further overlays the program guide information onto a secondary analog or digital video signal to generate the output video display signal.

13. The video program guide system of claim 9 further comprises a tuner control unit wherein said tuner control unit controls an internal or external channel tuner to select a video channel for viewing at a selected starting time.

14. The video program guide system of claim 1 further comprises a recorder control unit wherein said recorder control unit controls a video recording device to record a selected program at the selected time. Said video program guide system may optionally send a title screen to the recording device to describe the channel number, channel name, program time, or program name.

15. A video program guide system comprising:
(a) a primary analog video signal input line;
(b) a primary analog video signal interface unit;
(c) a screen image processing unit;
(d) a program guide data storage unit;
(e) a program guide display unit;
wherein said primary analog video signal interface unit receives a primary video signal from said primary analog video signal input line to said screen image processing unit;
wherein primary first video signal contains a plurality of screen images that contains channel numbers in numeric font image form and program entries in alphanumeric font image form or in bitmap image form;
wherein one or more said screen image contains a plurality of special bitmap image patterns in selected screen areas which carries program guide information;
wherein said screen image processing unit analyzes said screen images to retrieve the program guide information and stores into said program guide data storage unit;
wherein said screen image processing unit analyzes said special bitmap image patterns to retrieve a part of the program guide information;
wherein said program guide display unit uses the program guide information to generate an output video display signal.

16. The video program guide system of claim 15, wherein said primary video signal is from a local or remote video source, such as cable, broadcast, satellite, VCR, VCD, DVD, or other video producing or recording devices.

17. The video program guide system of claim 15,
wherein said screen image processing unit stores the program guide information in character form, full screen image, partial screen image, or selected screen image areas;
wherein said screen image processing unit stores the screen image or image areas in full bitmap, simplified, modified, or compressed forms.

18. The video program guide system of claim 15 wherein said screen image processing unit further performs image-processing or character-recognition operations to transform selected parts of the source video screen into numeric or alphabetic characters.

19. The video program guide system of claim 15 wherein said video display unit further overlays, the program guide information onto a secondary analog or digital video signal to generate the output video display signal.

20. The video program guide system of claim 15 further comprises a tuner control unit wherein said tuner control unit controls an internal or external channel tuner to select a video channel for viewing at a selected starting time.

21. The video program guide system of claim 1 further comprises a recorder control unit wherein said recorder control unit controls a video recording device to record a selected program at the selected time. Said video program guide system may optionally send a title screen to the recording device to describe the channel number, channel name, program time, or program name.
